(19) United States
(12) Patent Application Publication
(10) Pub. No.: US 2026/0278167 A1
(43) Pub. Date: Sep. 17, 2026

(54) SYSTEM FOR PROCESSING ANONYMIZED DATA USING GENERATIVE AI

(71) Applicant: SoftBank Group Corp., Tokyo (JP)

(72) Inventor: Kengo MATSUMOTO, Tokyo (JP)

(21) Appl. No.: 19/562,809

(22) Filed: Mar. 11, 2026

Related U.S. Application Data
(60) Provisional application No. 63/772,761, filed on Mar. 17, 2025.

(51) Int. Cl. G06F 21/62

(52) U.S. Cl. CPC G06F 21/6254

(57) ABSTRACT

A system for processing anonymized data reduces the risk of leakage of personal information and confidential corporate information when using generative AI. This system includes an input unit, a specifying unit, an anonymization unit, a transmission unit, a reception unit, a decryption unit, and a user interface unit. The input unit receives data from a user, and the specifying unit specifies personal information using natural language processing technology. The anonymization unit replaces the specified information with general labels, and the transmission unit transmits the data to the generative AI. The generative AI generates a response based on the anonymized data, and the reception unit receives this. The decryption unit restores the response to the original information and provides it to the user through the user interface unit.

### CROSS-REFERENCE TO RELATED APPLICATIONS

This application is based upon and claims the benefit of priority from U.S. Provisional Patent Application No. 63/772,761, filed on Mar. 17, 2025, the entire contents of which are incorporated herein by reference.

### BACKGROUND

Japanese Unexamined Patent Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

The problem to be solved by this disclosure is to reduce the risk of leakage of personal information and confidential corporate information that companies face when using generative AI, and to handle information safely. For example, an object is to minimize the risk of information leakage by ensuring that personal information and confidential corporate information are appropriately anonymized without being transmitted to the outside in information processing using generative AI. Although companies need to handle information in a manner that complies with the Personal Information Protection Act and corporate information security policies while enjoying the convenience of generative AI, related art systems have been insufficient in this regard. Disclosed herein is a process of anonymizing data including personal information in advance and de-anonymizing a response from a generative AI by using an anonymizing AI that operates in a local environment. This process enables companies to safely process information without leakage of personal information or confidential corporate information to the outside while utilizing generative AI. Thereby, companies can reduce the risk of information leakage associated with the introduction of generative AI and can utilize generative AI for business with peace of mind.

A system for safely transmitting data including personal information to a generative AI and receiving a response is provided. This system includes a specifying unit that receives input data including personal information and identifies specific personal information from the data. The specifying unit accurately specifies personal information and confidential corporate information in the input data using natural language processing technology. Next, the system includes an anonymization unit that anonymizes the specified personal information, and the anonymization unit anonymizes the data by replacing the specified information with general labels or codes. This anonymized data is transmitted to the generative AI through a transmission unit for transmitting to an external generative AI. A response from the generative AI is received via a reception unit and returned in an anonymized state. In order to decrypt this received response back to the original personal information, a decryption unit is provided, and the decryption unit refers to the labels and codes used during anonymization to restore the response to a form including the original personal information. Thereby, it becomes possible to safely utilize the convenience of generative AI without personal information or confidential corporate information leaking to the outside. Since this system operates in a local environment, it can meet the security requirements for companies using generative AI while minimizing the risk of information leakage.

### BRIEF DESCRIPTION OF THE DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example of a method of causing a generative AI to process anonymized data.

### DETAILED DESCRIPTION

Hereinafter, example systems according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### First Embodiment

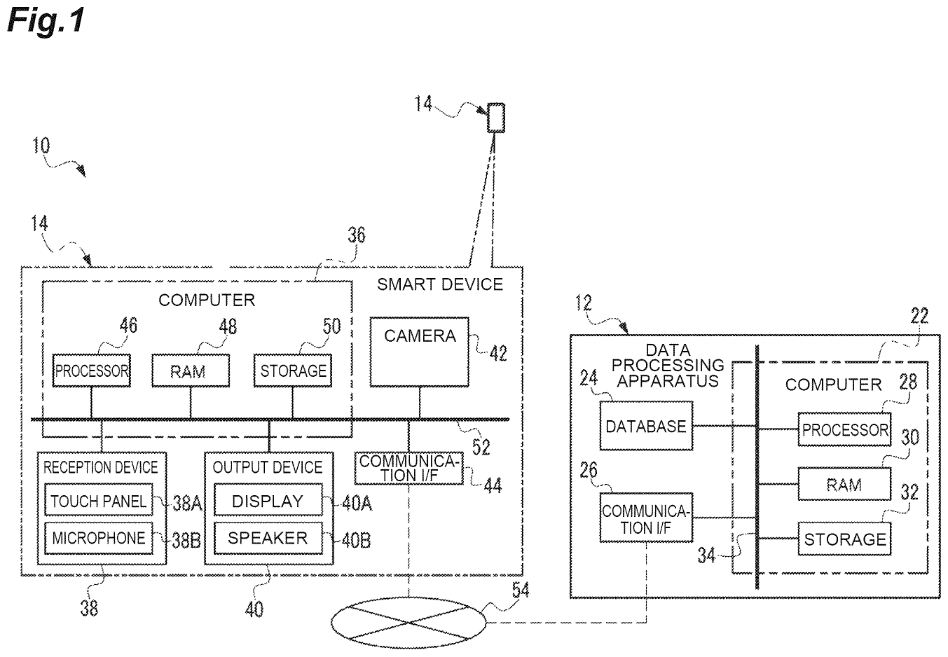

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specifying processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

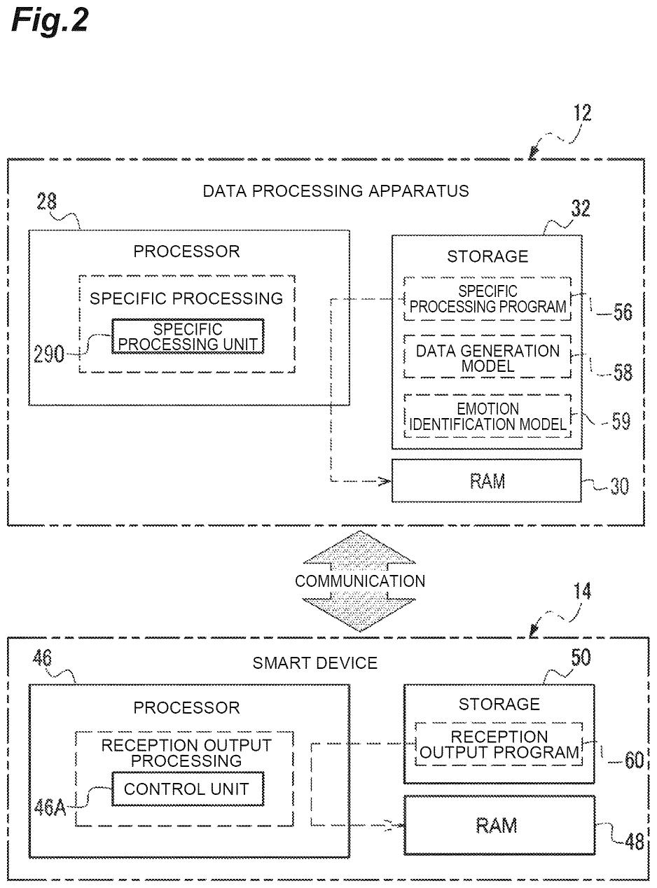

FIG. 2 illustrates an example of main functions of the data processing apparatus 12 and the smart device 14.

As illustrated in FIG. 2, in the data processing apparatus 12, a specifying process is performed by the processor 28. A specifying processing program 56 is stored in the storage 32. The specifying processing program 56 is an example of a “program” according to the technology of the present disclosure. The processor 28 reads the specifying processing program 56 from the storage 32 and executes the read specifying processing program 56 on the RAM 30. The specifying process is realized by the processor 28 operating as a specifying processing unit 290 in accordance with the specifying processing program 56 executed on the RAM 30.

The specification and anonymization of personal information by the specifying processing unit 290 are executed according to the following specific algorithm.

(1) Morphological analysis and Named Entity Recognition (NER) are executed on input data to extract entities such as person names, organization names, place names, and dates.

(2) A confidentiality score is calculated for each extracted entity. This score is calculated based on a degree of matching with predefined dictionary data and context (dependency relations with preceding and succeeding words).

(3) An entity whose confidentiality score exceeds a predetermined threshold is selected as “specific personal information.”

(4) A unique identifier (token) is generated for the selected specific personal information. This token generation is performed using an irreversible hash function or random generation logic while maintaining the character count or attributes (e.g., “USER ID” for a person name, “LOC_ID” for a place) of the original information.

(5) An “anonymization map” including a correspondence relationship between the specific personal information and the token, and position information (offset) of the specific personal information within the input data is generated in a secure area in the RAM 30.

This series of processes is automatically performed by a natural language processing engine, and it is impossible for a human to perform them manually from the viewpoint of time constraints and computational complexity.

A data generation model 58 and an emotion identification model 59 are stored in the storage 32. The data generation model 58 and the emotion identification model 59 are used by the specifying processing unit 290. The specifying processing unit 290 can estimate a user's emotion using the emotion identification model 59 and perform a specifying process using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart device 14, a reception output process is performed by the processor 46. A reception output program 60 is stored in the storage 50. The reception output program 60 is used in combination with the specifying processing program 56 by the data processing system 10. The processor 46 reads the reception output program 60 from the storage 50 and executes the read reception output program 60 on the RAM 48. The specifying process is realized by the processor 46 operating as a control unit 46A in accordance with the reception output program 60 executed on the RAM 48. Note that the smart device 14 can also have a data generation model and an emotion identification model similar to the data generation model 58 and the emotion identification model 59, and perform processing similar to that of the specifying processing unit 290 using these models. The reception output process is realized by the processor 46 operating as the control unit 46A in accordance with the reception output program 60 executed on the RAM 48.

Communication between the data processing apparatus 12 and the smart device 14 and communication between the data processing apparatus 12 and the external generative AI (data generation model 58) in the present system may be performed by asynchronous stream processing. Specifically, when the input data is a long text, the specifying processing unit 290 divides the input data into a plurality of chunks and performs anonymization processing and transmission to the generative AI in parallel for each chunk. The reception unit and the decryption unit sequentially perform decryption processing on response chunks returned from the generative AI in a streaming format, and present the chunks to the user after buffering. This minimizes an increase in latency (delay) due to the addition of anonymization/decryption processing for personal information protection, and realizes secure interaction without impairing real-time performance. This parallel distributed processing is optimized using a plurality of processor cores or GPUs, and provides a response speed that cannot be achieved by single sequential processing.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1.1

A flow of a specifying process in Example 1.1 will be described. Each unit of the system described below is realized by the data processing apparatus 12 and the smart device 14. Also, the data processing apparatus 12 is referred to as a “server”, and the smart device 14 is referred to as a “terminal”.

A system configuration using a server and a terminal ill be described in further detail.

This system distributes and realizes functions on both a terminal used by a user and a server that performs data processing. First, the terminal provides a user interface and includes an input unit for the user to input data including personal information. For example, a user uses an application on a smartphone or a personal computer to input a question such as “I want to know the phone number of Taro Tanaka”. This input data is sent to a specifying unit operating on the terminal.

The input unit may be configured by, for example, the reception device 38 (the touch panel 38A, the microphone 38B, etc.) of the smart device 14.

The specifying unit analyzes the input data using natural language processing technology to specify personal information and confidential corporate information. This specifying unit, for example, implements an advanced algorithm for identifying information such as names, addresses, phone numbers, email addresses, social security numbers, and credit card information. The specifying unit is designed to utilize a machine learning model to specify information according to the context and to minimize false detections. The specified personal information is passed to an anonymization unit on the terminal.

The specifying unit may be configured by, for example, the computer 36 (the processor 46, etc.) of the smart device 14, or may be configured by the control unit 46A, the reception output program 60, or the like.

The anonymization unit has a function of anonymizing the specified personal information. For example, it replaces the specified information with general labels or codes. For example, it converts “Taro Tanaka” to “User A” and “phone number” to “Data X”. This anonymization process is for making it impossible to identify a specific individual or company while retaining the content of the information. The anonymization unit applies different anonymization methods according to the type of information to ensure the confidentiality of the information.

The anonymization unit may be configured by, for example, the computer 36 (the processor 46, etc.) of the smart device 14, or may be configured by the control unit 46A, the reception output program 60, or the like.

The specifying unit and the anonymization unit may be executed within a Trusted Execution Environment (TEE) or a secure enclave in the computer. Thereby, the specification and anonymization processing of personal information are executed in a memory area isolated from an operating system (OS) and other applications, preventing raw data prior to anonymization from being read by other processes in the device at a hardware level.

The anonymized data is transmitted from the terminal to the server. The transmission unit of the terminal that transmits data to the server may be configured by, for example, the communication I/F 44 of the smart device 14. The server includes a reception unit that receives the transmitted anonymized data. The reception unit safely receives the data from the terminal and prepares to pass it to a generative AI. A transmission unit on the server plays the role of transmitting the anonymized data to the generative AI. The generative AI operates on the server or may be used as an external cloud service. The generative AI uses natural language processing and machine learning technology to generate a response based on the anonymized question.

The response from the generative AI is received by the reception unit on the server and transmitted to the terminal again. The terminal receives the response from the server and passes it to a decryption unit for de-anonymization. The reception unit of the terminal that receives data from the server may be configured by, for example, the communication I/F 44 of the smart device 14. The decryption unit refers to the labels and codes used during anonymization and restores the response to a form including the original personal information. For example, it decrypts a response such as “Data X for User A is 123-456-7890” to “The phone number of Taro Tanaka is 123-456-7890”. This decryption process is for accurately restoring the original information while maintaining the integrity of the information.

The decrypted response is provided to the user through the user interface. The user can check the decrypted information on the terminal and ask further questions as necessary. In this way, by the terminal and the server operating in cooperation, it becomes possible to safely utilize the convenience of generative AI without personal information or confidential corporate information leaking to the outside. This system can meet the security requirements for companies using generative AI while minimizing the risk of information leakage. Furthermore, the system is designed with scalability in mind and can flexibly adapt to companies of different sizes and in different industries.

The decryption unit may be configured to compare a token (label or code) included in a response from the generative AI with a temporary mapping table (correspondence table) generated by the anonymization unit, wherein the mapping table is held only on a volatile memory and is immediately discarded after a session ends or after a predetermined time elapses. This leaves no traces of personal information in persistent storage, and since only anonymized tokens are passed to the generative AI side, restoration of personal information from learning data by a Model Inversion Attack or the like is made mathematically impossible. Decryption processing by the decryption unit (the control unit 46A or the specifying processing unit 290) is executed according to the following specific algorithm.

(1) The response text received from the generative AI is analyzed to search whether or not a token included in the “anonymization map” is included.

(2) For a token detected in the response text, the original specific personal information is acquired with reference to the anonymization map.

(3) Here, when the generative AI performs a word form change (e.g., change to a possessive case, etc.) of the token according to the context, the deformed token is identified as the same token by regular expression matching or approximate matching using Levenshtein distance.

(4) The identified token is replaced with the original specific personal information to generate final output data.

By this processing, even if the generative AI reconstructs the context in a response generation process, it becomes possible to accurately embed back the original personal information, and data consistency is maintained.

The decryption unit may be configured by, for example, the computer 36 (the processor 46, etc.) of the smart device 14, or may be configured by the control unit 46A, the reception output program 60, or the like.

### (System Configuration)

The system includes an input unit, a specifying unit, an anonymization unit, a transmission unit, a reception unit, a decryption unit, and a user interface unit. The input unit provides an interface for a user to input data including personal information. For example, a user can use an application on a smartphone or a personal computer to input a question such as “I want to know the phone number of Taro Tanaka”. This input unit supports various input means such as a touch screen, a keyboard, and voice input, and is designed to be intuitively operable by the user.

The specifying unit has a function of analyzing the input data and specifying personal information and confidential corporate information. The specifying unit uses natural language processing technology to identify names, addresses, phone numbers, email addresses, social security numbers, credit card information, and the like. For example, it specifies a name such as “Taro Tanaka” from an input sentence and marks this as personal information. Also, the specifying unit understands the context and can, for example, specify the email address of a supervisor from the expression “my supervisor's email address”. Furthermore, the specifying unit utilizes a machine learning model and can, for example, accurately specify new forms of personal information when they are input, based on past data.

The anonymization unit has a function of anonymizing the specified personal information. For example, it replaces the specified information with general labels or codes. For example, it converts “Taro Tanaka” to “User A” and “phone number” to “Data X”. This anonymization process is for making it impossible to identify a specific individual or company while retaining the content of the information. The anonymization unit applies different anonymization methods according to the type of information, and for example, ensures the confidentiality of information by converting an address to a regional code or an email address to only a domain name.

The transmission unit plays the role of transmitting the anonymized data to a generative AI. The transmission unit uses encryption technology for securely transmitting data to transmit the data to an external generative AI. For example, it uses protocols such as TLS and SSL to prevent interception by a third party during data transmission. Also, the transmission unit manages the destination of the data and can, for example, be configured to transmit data only to a specific generative AI service.

The reception unit has a function of receiving a response from the generative AI. The reception unit, similar to the transmission unit, uses encryption technology to receive data and prevents unauthorized access from the outside. For example, when receiving a response from the generative AI, it confirms the integrity of the data and ensures that it has not been tampered with. Also, the reception unit appropriately processes the received data and prepares to pass it to the decryption unit.

The decryption unit has a function for decrypting the anonymized response to the original personal information. The decryption unit refers to the labels and codes used during anonymization and restores the response to a form including the original personal information. For example, it decrypts a response such as “Data X for User A is 123-456-7890” to “The phone number of Taro Tanaka is 123-456-7890”. This decryption process is for accurately restoring the original information while maintaining the integrity of the information.

The user interface unit includes an interface for providing the decrypted response to the user. The user can check the decrypted information on the terminal and ask further questions as necessary. For example, the user can input a new question based on the decrypted information and use the system again. The user interface unit adopts a visually easy-to-understand design and is designed so that the user can easily understand the information.

Specific examples of prompt sentences to be read into the generative AI include “Please provide the latest information regarding Data X of User A” and “Please tell me the history of Data X of User A”. This allows the generative AI to generate an appropriate response based on the anonymized data.

### (Implementation Steps)

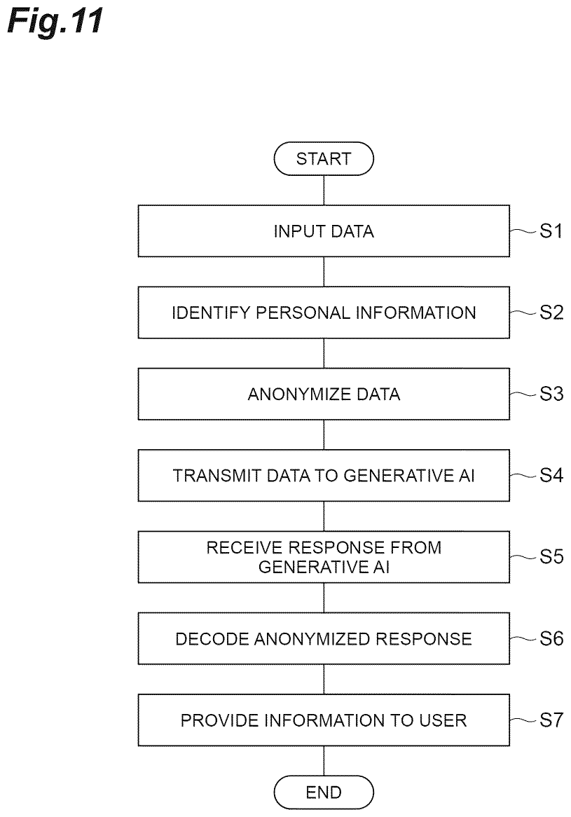

### Step 1: Data Input (Refer to Step S1 of FIG. 11)

A user inputs data including personal information through an input unit of a terminal. This input is performed, for example, using an application on a smartphone or a personal computer. The user can input a question such as “I want to know the phone number of Taro Tanaka”. The input unit supports various input means such as a touch screen, a keyboard, and voice input, and is designed to be intuitively operable by the user.

### Step 2: Specification of Personal Information (Refer to Step S2 of FIG. 11)

The input data is sent to a specifying unit on the terminal and analyzed using natural language processing technology. The specifying unit identifies names, addresses, phone numbers, email addresses, social security numbers, credit card information, and the like. For example, it specifies a name such as “Taro Tanaka” from an input sentence and marks this as personal information. Also, the specifying unit understands the context and can, for example, specify the email address of a supervisor from the expression “my supervisor's email address”. Furthermore, the specifying unit utilizes a machine learning model and can, for example, accurately specify new forms of personal information when they are input, based on past data.

### Step 3: Data Anonymization (Refer to Step S3 of FIG. 11)

The specified personal information is passed to an anonymization unit on the terminal, and an anonymization process is performed. For example, it replaces the specified information with general labels or codes. For example, it converts “Taro Tanaka” to “User A” and “phone number” to “Data X”. This anonymization process is for making it impossible to identify a specific individual or company while retaining the content of the information. The anonymization unit applies different anonymization methods according to the type of information, and for example, ensures the confidentiality of information by converting an address to a regional code or an email address to only a domain name.

### Step 4: Data Transmission to Generative AI (Refer to Step S4 of FIG. 11)

The anonymized data is transmitted from the terminal to a server and transmitted to a generative AI through a transmission unit on the server. The transmission unit uses encryption technology for securely transmitting data to transmit the data to an external generative AI. For example, it uses protocols such as TLS and SSL to prevent interception by a third party during data transmission. Also, the transmission unit manages the destination of the data and can, for example, be configured to transmit data only to a specific generative AI service. Specific examples of prompt sentences to be read into the generative AI include “Please provide the latest information regarding Data X of User A” and “Please tell me the history of Data X of User A”.

Step 5: Response Reception from Generative AI (Refer to Step S5 of FIG. 11)

The generative AI generates a response based on the anonymized question, and the response is received by a reception unit on the server. The reception unit, similar to the transmission unit, uses encryption technology to receive data and prevents unauthorized access from the outside. For example, when receiving a response from the generative AI, it confirms the integrity of the data and ensures that it has not been tampered with. Also, the reception unit appropriately processes the received data and prepares to pass it to the decryption unit.

### Step 6: De-Anonymization of Response (Refer to Step S6 of FIG. 11)

The received response is passed to a decryption unit of the terminal, which decrypts the anonymized information to the original personal information. The decryption unit refers to the labels and codes used during anonymization and restores the response to a form including the original personal information. For example, it decrypts a response such as “Data X for User A is 123-456-7890” to “The phone number of Taro Tanaka is 123-456-7890”. This decryption process is for accurately restoring the original information while maintaining the integrity of the information.

### Step 7: Information Provision to User (Refer to Step S7 of FIG. 11)

The decrypted response is provided to the user through a user interface unit. The user can check the decrypted information on the terminal and ask further questions as necessary. For example, the user can input a new question based on the decrypted information and use the system again. The user interface unit adopts a visually easy-to-understand design and is designed so that the user can easily understand the information.

### (Specific Use Case)

For example, a certain company aims to respond to inquiries from customers quickly and accurately by utilizing a generative AI in its customer support operations. Since inquiries from customers often include personal information, this company needs to minimize the risk of information leakage. Therefore, by introducing the system, it becomes possible to utilize the generative AI while handling personal information safely.

When a customer makes an inquiry to a support contact, such as “Please tell me the delivery status of my order number 12345,” this information is first input through an input unit of a terminal. The input data is analyzed by a specifying unit, and “order number 12345” is specified as personal information. The specified information is passed to an anonymization unit and anonymized by replacing “order number 12345” with a general label such as “Order ID A”.

The anonymized data is transmitted to a generative AI via a server. A specific example of a prompt sentence to be read into the generative AI is “Please check the delivery status of Order ID-A”. The generative AI generates a delivery status corresponding to the anonymized data based on this prompt.

The response from the generative AI is received by a reception unit of the server and passed to a decryption unit of the terminal. The decryption unit refers to the label used during anonymization and restores “Order ID-A” to “order number 12345”. As a result, the response is decrypted in a form such as “The delivery status of order number 12345 is currently in transit”.

The decrypted response is provided to the customer through a user interface unit. The customer can check the decrypted information on the terminal and make further inquiries as necessary. In this way, by using the system, a company can streamline its customer support operations by utilizing a generative AI while handling personal information safely.

### Example 1.2

A flow of a specifying process in Application Example 1.2 will be described. Each unit of the system described below is realized by the data processing apparatus 12 and the smart device 14. Also, the data processing apparatus 12 is referred to as a “server”, and the smart device 14 is referred to as a “terminal”.

A specific system configuration in the nursing care field will be described in further detail.

This system is designed to safely handle information regarding the health condition and care plan of users in a nursing care facility and to propose an optimal care plan using a generative AI. The system includes an input unit, a specifying unit, an anonymization unit, a transmission unit, a reception unit, a decryption unit, and a user interface unit.

The input unit provides an interface for care staff to input detailed health information of a user. For example, it includes the user's name, age, gender, medical history, allergy information, current health condition (blood pressure, heart rate, body temperature, etc.), medication information, dietary restrictions, evaluation of activities of daily living, psychological state, family structure, and emergency contact information. Since this information differs for each user, it is input individually. The input unit supports various input means such as a touch screen, a keyboard, and voice input, and is designed to be intuitively operable by care staff. For example, by using voice input, it is possible to quickly input information even when hands are occupied.

The specifying unit has a function of analyzing the input data and specifying personal information and confidential information. The specifying unit uses natural language processing technology to identify names, addresses, health information, contact information, and the like, and marks these as personal information. For example, it specifies a name such as “Ichiro Tanaka” from an input sentence and marks this as personal information. Also, the specifying unit understands the context and can, for example, specify the email address of a supervisor from the expression “my supervisor's email address”. Furthermore, the specifying unit utilizes a machine learning model and can, for example, accurately specify new forms of personal information when they are input, based on past data. The specifying unit improves data accuracy by integrating information from multiple data sources and eliminating duplicates and contradictions.

The anonymization unit has a function of anonymizing the specified personal information. For example, it replaces the specified information with general labels or codes. For example, it converts “Ichiro Tanaka” to “User A” and “hypertension” to “Health Condition X”. This anonymization process is for making it impossible to identify a specific individual or company while retaining the content of the information. The anonymization unit applies different anonymization methods according to the type of information, and for example, ensures the confidentiality of information by converting an address to a regional code or an email address to only a domain name. Furthermore, the anonymization unit can adjust the level of anonymization of information and can implement stricter anonymization as necessary.

The transmission unit plays the role of transmitting the anonymized data to a generative AI. The transmission unit uses encryption technology for securely transmitting data to transmit the data to an external generative AI. For example, it uses protocols such as TLS and SSL to prevent interception by a third party during data transmission. Also, the transmission unit manages the destination of the data and can, for example, be configured to transmit data only to a specific generative AI service. A specific example of a prompt sentence to be read into the generative AI is “Please propose an optimal care plan based on User A's Health Condition X, age, and medical history”. The transmission unit is provided with a check function to confirm the integrity of the data before transmission and prevent erroneous transmission.

The reception unit has a function of receiving a response from the generative AI. The reception unit, similar to the transmission unit, uses encryption technology to receive data and prevents unauthorized access from the outside. For example, when receiving a response from the generative AI, it confirms the integrity of the data and ensures that it has not been tampered with. Also, the reception unit appropriately processes the received data and prepares to pass it to the decryption unit. The reception unit is provided with a function to record a timestamp of the received data and confirm the freshness of the data.

The decryption unit has a function for decrypting the anonymized response to the original personal information. The decryption unit refers to the labels and codes used during anonymization and restores the response to a form including the original personal information. For example, it decrypts a response such as “The care plan for User A is as follows” to “The care plan for Ichiro Tanaka is as follows”. This decryption process is for accurately restoring the original information while maintaining the integrity of the information. The decryption unit is provided with a function to record a log of the decryption process and save it in a verifiable form for later.

The user interface unit includes an interface for providing the decrypted response to care staff. The care staff can check the decrypted information on the terminal and ask further questions as necessary. For example, the care staff can input a new question based on the decrypted information and use the system again. The user interface unit adopts a visually easy-to-understand design and is designed so that the care staff can easily understand the information. The user interface unit is provided with a voice guide and a help function to support even staff unfamiliar with the operation to use it smoothly.

In this way, the system makes it possible to provide high-quality care by utilizing a generative AI while safely handling personal information in a nursing care facility. This is expected to lead to efficient health management of users and an improvement in the quality of care. Furthermore, the system is designed with scalability in mind and can flexibly adapt to facilities of different sizes and regulations in different regions.

### (System Configuration)

The system includes an input unit, a specifying unit, an anonymization unit, a transmission unit, a reception unit, a decryption unit, and a user interface unit. The input unit provides an interface for care staff to input detailed health information of a user. For example, it includes the user's name, age, gender, medical history, allergy information, current health condition (blood pressure, heart rate, body temperature, etc.), medication information, dietary restrictions, evaluation of activities of daily living, psychological state, family structure, and emergency contact information. The input unit supports various input means such as a touch screen, a keyboard, and voice input, and is designed to be intuitively operable by care staff. For example, by using voice input, it is possible to quickly input information even when hands are occupied. Also, the input data is saved in real time and recorded in a form that can be referred to later.

The specifying unit has a function of analyzing the input data and specifying personal information and confidential information. The specifying unit uses natural language processing technology to identify names, addresses, health information, contact information, and the like, and marks these as personal information. For example, it specifies a name such as “Ichiro Tanaka” from an input sentence and marks this as personal information. Also, the specifying unit understands the context and can, for example, specify the email address of a supervisor from the expression “my supervisor's email address”. Furthermore, the specifying unit utilizes a machine learning model and can, for example, accurately specify new forms of personal information when they are input, based on past data. The specifying unit improves data accuracy by integrating information from multiple data sources and eliminating duplicates and contradictions.

The anonymization unit has a function of anonymizing the specified personal information. For example, it replaces the specified information with general labels or codes. For example, it converts “Ichiro Tanaka” to “User A” and “hypertension” to “Health Condition X”. This anonymization process is for making it impossible to identify a specific individual or company while retaining the content of the information. The anonymization unit applies different anonymization methods according to the type of information, and for example, ensures the confidentiality of information by converting an address to a regional code or an email address to only a domain name. Furthermore, the anonymization unit can adjust the level of anonymization of information and can implement stricter anonymization as necessary.

The transmission unit plays the role of transmitting the anonymized data to a generative AI. The transmission unit uses encryption technology for securely transmitting data to transmit the data to an external generative AI. For example, it uses protocols such as TLS and SSL to prevent interception by a third party during data transmission. Also, the transmission unit manages the destination of the data and can, for example, be configured to transmit data only to a specific generative AI service. A specific example of a prompt sentence to be read into the generative AI is “Please propose an optimal care plan based on User A's Health Condition X, age, and medical history”. The transmission unit is provided with a check function to confirm the integrity of the data before transmission and prevent erroneous transmission.

The reception unit has a function of receiving a response from the generative AI. The reception unit, similar to the transmission unit, uses encryption technology to receive data and prevents unauthorized access from the outside. For example, when receiving a response from the generative AI, it confirms the integrity of the data and ensures that it has not been tampered with. Also, the reception unit appropriately processes the received data and prepares to pass it to the decryption unit. The reception unit is provided with a function to record a timestamp of the received data and confirm the freshness of the data.

The decryption unit has a function for decrypting the anonymized response to the original personal information. The decryption unit refers to the labels and codes used during anonymization and restores the response to a form including the original personal information. For example, it decrypts a response such as “The care plan for User A is as follows” to “The care plan for Ichiro Tanaka is as follows”. This decryption process is for accurately restoring the original information while maintaining the integrity of the information. The decryption unit is provided with a function to record a log of the decryption process and save it in a verifiable form for later.

The user interface unit includes an interface for providing the decrypted response to care staff. The care staff can check the decrypted information on the terminal and ask further questions as necessary. For example, the care staff can input a new question based on the decrypted information and use the system again. The user interface unit adopts a visually easy-to-understand design and is designed so that the care staff can easily understand the information. The user interface unit is provided with a voice guide and a help function to support even staff unfamiliar with the operation to use it smoothly.

In this way, the system makes it possible to provide high-quality care by utilizing a generative AI while safely handling personal information in a nursing care facility. This is expected to lead to efficient health management of users and an improvement in the quality of care. Furthermore, the system is designed with scalability in mind and can flexibly adapt to facilities of different sizes and regulations in different regions.

### (Implementation Steps)

### Step 1: Data Input

Care staff input detailed information regarding a user's health condition and care plan into a terminal. This information includes the user's name, age, gender, medical history, allergy information, current health condition (blood pressure, heart rate, body temperature, etc.), medication information, dietary restrictions, evaluation of activities of daily living, psychological state, family structure, and emergency contact information. The input unit supports various input means such as a touch screen, a keyboard, and voice input, and is designed to be intuitively operable by care staff. For example, by using voice input, it is possible to quickly input information even when hands are occupied.

### Step 2: Specification of Personal Information

The input data is sent to a specifying unit and analyzed using natural language processing technology. The specifying unit identifies names, addresses, health information, contact information, and the like, and marks these as personal information. For example, it specifies a name such as “Ichiro Tanaka” from an input sentence and marks this as personal information. Also, the specifying unit understands the context and can, for example, specify the email address of a supervisor from the expression “my supervisor's email address”. Furthermore, the specifying unit utilizes a machine learning model and can, for example, accurately specify new forms of personal information when they are input, based on past data.

### Step 3: Data Anonymization

The specified personal information is passed to an anonymization unit, and an anonymization process is performed. For example, it replaces the specified information with general labels or codes. For example, it converts “Ichiro Tanaka” to “User A” and “hypertension” to “Health Condition X”. This anonymization process is for making it impossible to identify a specific individual or company while retaining the content of the information. The anonymization unit applies different anonymization methods according to the type of information, and for example, ensures the confidentiality of information by converting an address to a regional code or an email address to only a domain name.

### Step 4: Data Transmission to Generative AI

The anonymized data is transmitted to a generative AI through a transmission unit. The transmission unit uses encryption technology for securely transmitting data to transmit the data to an external generative AI. For example, it uses protocols such as TLS and SSL to prevent interception by a third party during data transmission. Also, the transmission unit manages the destination of the data and can, for example, be configured to transmit data only to a specific generative AI service. A specific example of a prompt sentence to be read into the generative AI is “Please propose an optimal care plan based on User A's Health Condition X, age, and medical history”.

Step 5: Response Reception from Generative AI

The generative AI generates a care plan based on the anonymized data, and the response is received by a reception unit. The reception unit, similar to the transmission unit, uses encryption technology to receive data and prevents unauthorized access from the outside. For example, when receiving a response from the generative AI, it confirms the integrity of the data and ensures that it has not been tampered with. Also, the reception unit appropriately processes the received data and prepares to pass it to the decryption unit.

### Step 6: De-Anonymization of Response

The received response is passed to a decryption unit, which decrypts the anonymized information to the original personal information. The decryption unit refers to the labels and codes used during anonymization and restores the response to a form including the original personal information. For example, it decrypts a response such as “The care plan for User A is as follows” to “The care plan for Ichiro Tanaka is as follows”. This decryption process is for accurately restoring the original information while maintaining the integrity of the information.

### Step 7: Provision of Care Plan

The decrypted care plan is provided to care staff through a user interface unit. The care staff can check the decrypted information on the terminal and ask further questions as necessary. For example, the care staff can input a new question based on the decrypted information and use the system again. The user interface unit adopts a visually easy-to-understand design and is designed so that the care staff can easily understand the information.

### (Specific Use Case)

For example, in a certain nursing care facility, the system is introduced to optimize the health management and care plans of users. In this facility, it is required to grasp the health condition of each user in detail and provide an individually optimized care plan. Therefore, care staff input the health information of users into a terminal. The input information includes the user's name, age, gender, medical history, allergy information, current health condition (blood pressure, heart rate, body temperature, etc.), medication information, dietary restrictions, evaluation of activities of daily living, psychological state, family structure, and emergency contact information.

The input data is analyzed by a specifying unit, and personal information is specified. The specifying unit uses natural language processing technology to identify names, addresses, and health information, and marks these as personal information. For example, a name such as “Ichiro Tanaka” and a health condition such as “hypertension” are specified. The specified personal information is passed to an anonymization unit, and an anonymization process is performed. For example, it converts “Ichiro Tanaka” to “User A” and “hypertension” to “Health Condition X”.

The anonymized data is transmitted to a generative AI through a transmission unit. A specific example of a prompt sentence to be read into the generative AI is “Please propose an optimal care plan based on User A's Health Condition X, age, and medical history”. The generative AI generates an optimal care plan based on the anonymized data based on this prompt.

The response from the generative AI is received by a reception unit and passed to a decryption unit. The decryption unit refers to the labels and codes used during anonymization and restores the response to a form including the original personal information. For example, it decrypts a response such as “The care plan for User A is as follows” to “The care plan for Ichiro Tanaka is as follows”. The decrypted care plan is provided to the care staff through a user interface unit.

The care staff can check the decrypted information on the terminal and ask further questions as necessary. For example, it is possible to input a new question based on the decrypted information and use the system again. In this way, by using the system, a nursing care facility can provide high-quality care by utilizing a generative AI while safely handling the personal information of users. This is expected to lead to efficient health management of users and an improvement in the quality of care.

The specifying processing unit 290 transmits a result of the specifying process to the smart device 14. In the smart device 14, the control unit 46A causes the output device 40 to output the result of the specifying process. The microphone 38B acquires voice indicating a user input for the result of the specifying process. The control unit 46A transmits voice data indicating the user input acquired by the microphone 38B to the data processing apparatus 12. In the data processing apparatus 12, the specifying processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specifying processing unit 290 performs the above-described specifying process while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specifying processing unit 290 of the data processing apparatus 12 or the control unit 46A of the smart device 14, but may also be executed by the specifying processing unit 290 of the data processing apparatus 12 and the control unit 46A of the smart device 14. Also, the specifying processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specifying processing unit 290 of the data processing apparatus 12. For example, an acquisition unit acquires step count data using the camera 42 or the communication I/F 44 of the smart device 14, and the data is processed by the specifying processing unit 290 of the data processing apparatus 12. For example, an analysis unit is realized by the specifying processing unit 290 of the data processing apparatus 12, and analyzes data from the collection unit and the acquisition unit. For example, a generation unit is realized by the specifying processing unit 290 of the data processing apparatus 12, and generates a cooking menu using a generative AI. For example, a provision unit is realized by the output device 40 of the smart device 14 or the specifying processing unit 290 of the data processing apparatus 12, and provides the generated cooking menu to a user. The correspondence relationship between each unit and the device or the control unit is not limited to the above-described example, and various changes are possible.

An example form in which the specifying process is performed by the data processing apparatus 12 has been described, but the technology of the present disclosure is not limited to this, and the specifying process may be performed by the smart device 14.

### Second Embodiment

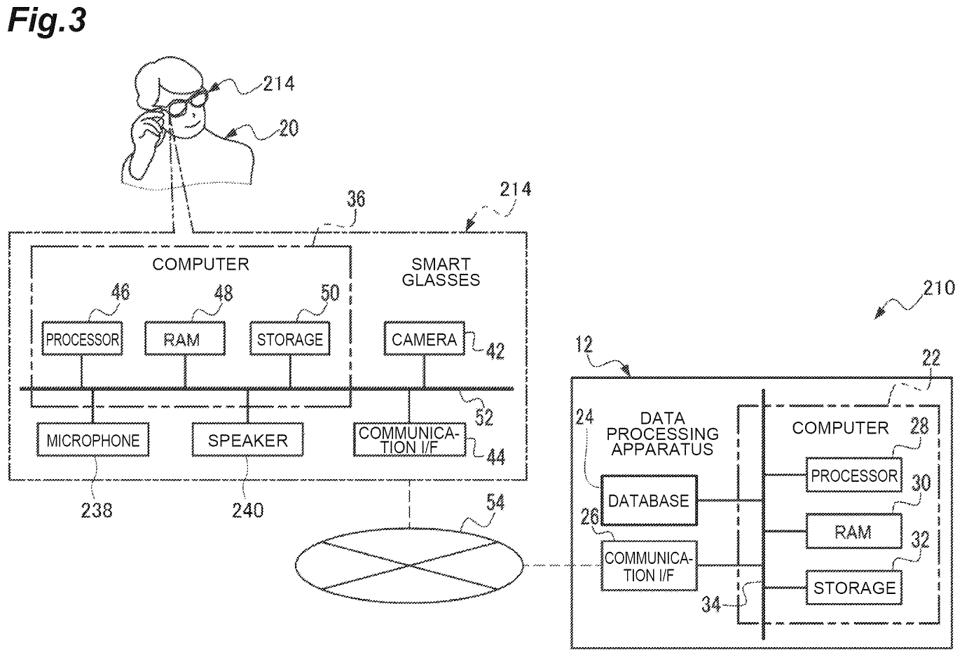

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

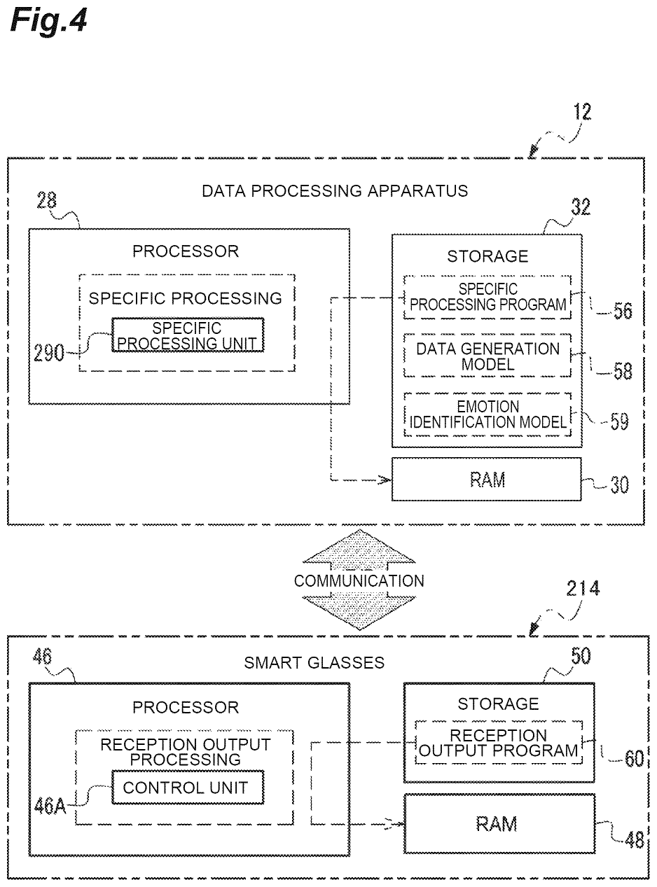

FIG. 4 illustrates an example of main functions of the data processing apparatus 12 and the smart glasses 214. As illustrated in FIG. 4, in the data processing apparatus 12, a specifying process is performed by the processor 28. A specifying processing program 56 is stored in the storage 32.

The specifying processing program 56 is an example of a “program” according to the technology of the present disclosure. The processor 28 reads the specifying processing program 56 from the storage 32 and executes the read specifying processing program 56 on the RAM 30. The specifying process is realized by the processor 28 operating as a specifying processing unit 290 in accordance with the specifying processing program 56 executed on the RAM 30.

A data generation model 58 and an emotion identification model 59 are stored in the storage 32. The data generation model 58 and the emotion identification model 59 are used by the specifying processing unit 290. The specifying processing unit 290 can estimate a user's emotion using the emotion identification model 59 and perform a specifying process using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart glasses 214, a reception output process is performed by the processor 46. A reception output program 60 is stored in the storage 50. The processor 46 reads the reception output program 60 from the storage 50 and executes the read reception output program 60 on the RAM 48. The reception output process is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specifying processing unit 290 using these models.

Next, a specifying process by the specifying processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 2.1

Since the flow of the specifying process is the same as that in Example 1 described in the first embodiment, a description thereof is omitted.

### Example 2.2

Since the flow of the specifying process is the same as that in Example 1 described in the first embodiment, a description thereof is omitted.

The specifying processing unit 290 transmits a result of the specifying process to the smart glasses 214. In the smart glasses 214, the control unit 46A causes the speaker 240 to output the result of the specifying process. The microphone 238 acquires voice indicating a user input for the result of the specifying process. The control unit 46A transmits voice data indicating the user input acquired by the microphone 238 to the data processing apparatus 12. In the data processing apparatus 12, the specifying processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specifying processing unit 290 performs the above-described specifying process while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specifying processing unit 290 of the data processing apparatus 12 or the control unit 46A of the smart device 14, but may also be executed by the specifying processing unit 290 of the data processing apparatus 12 and the control unit 46A of the smart device 14. Also, the specifying processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specifying processing unit 290 of the data processing apparatus 12. For example, an acquisition unit acquires step count data using the camera 42 or the communication I/F 44 of the smart device 14, and the data is processed by the specifying processing unit 290 of the data processing apparatus 12. For example, an analysis unit is realized by the specifying processing unit 290 of the data processing apparatus 12, and analyzes data from the collection unit and the acquisition unit. For example, a generation unit is realized by the specifying processing unit 290 of the data processing apparatus 12, and generates a cooking menu using a generative AI. For example, a provision unit is realized by the output device 40 of the smart device 14 or the specifying processing unit 290 of the data processing apparatus 12, and provides the generated cooking menu to a user. The correspondence relationship between each unit and the device or the control unit is not limited to the above-described example, and various changes are possible.

An example form in which the specifying process is performed by the data processing apparatus 12 has been described, but the technology of the present disclosure is not limited to this, and the specifying process may be performed by the smart glasses 214.

### Third Embodiment

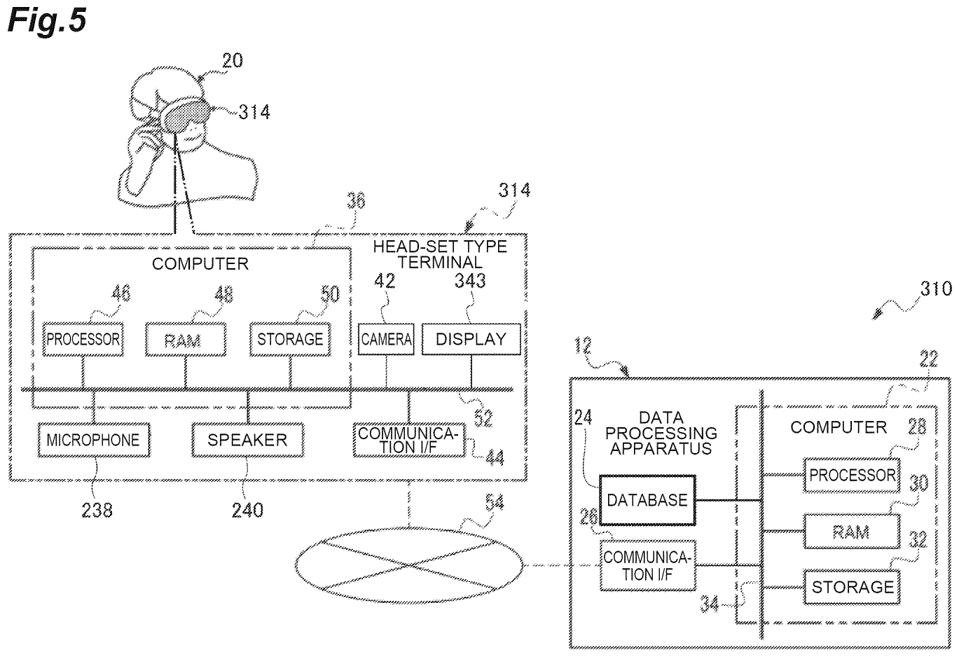

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

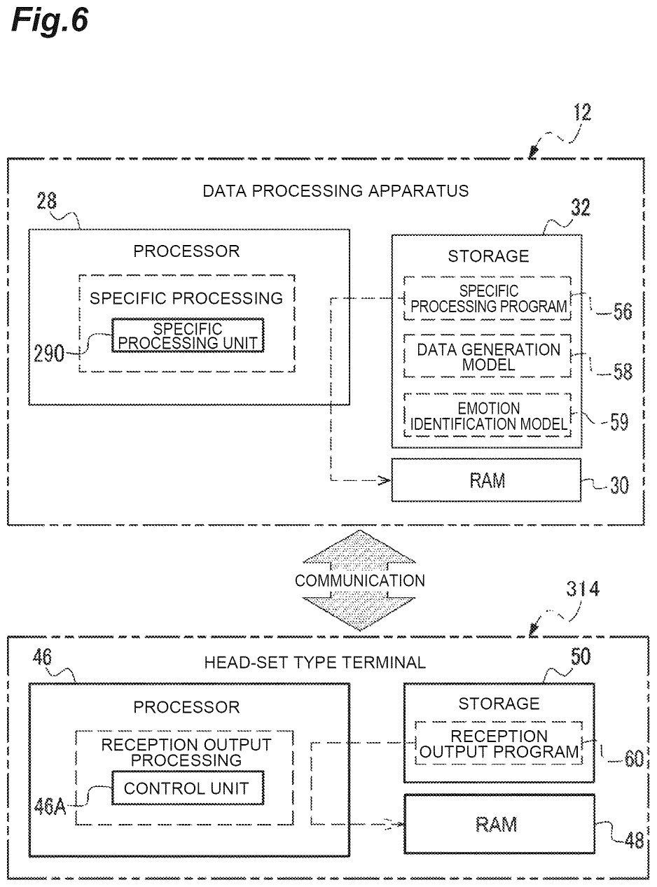

FIG. 6 illustrates an example of main functions of the data processing apparatus 12 and the headset-type terminal 314. As illustrated in FIG. 6, in the data processing apparatus 12, a specifying process is performed by the processor 28. A specifying processing program 56 is stored in the storage 32.

The specifying processing program 56 is an example of a “program” according to the technology of the present disclosure. The processor 28 reads the specifying processing program 56 from the storage 32 and executes the read specifying processing program 56 on the RAM 30. The specifying process is realized by the processor 28 operating as a specifying processing unit 290 in accordance with the specifying processing program 56 executed on the RAM 30.

A data generation model 58 and an emotion identification model 59 are stored in the storage 32. The data generation model 58 and the emotion identification model 59 are used by the specifying processing unit 290.

In the headset-type terminal 314, a reception output process is performed by the processor 46. A reception output program 60 is stored in the storage 50. The processor 46 reads the reception output program 60 from the storage 50 and executes the read reception output program 60 on the RAM 48. The reception output process is realized by the processor 46 operating as a control unit 46A in accordance with the reception output program 60 executed on the RAM 48.

Next, a specifying process by the specifying processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 3.1

Since the flow of the specifying process is the same as that in Example 1.1 described in the first embodiment, a description thereof is omitted.

### Example 3.2

Since the flow of the specifying process is the same as that in Example 1.2 described in the first embodiment, a description thereof is omitted.

The specifying processing unit 290 transmits a result of the specifying process to the headset-type terminal 314. In the headset-type terminal 314, the control unit 46A causes the speaker 240 and the display 343 to output the result of the specifying process. The microphone 238 acquires voice indicating a user input for the result of the specifying process. The control unit 46A transmits voice data indicating the user input acquired by the microphone 238 to the data processing apparatus 12. In the data processing apparatus 12, the specifying processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specifying processing unit 290 performs the above-described specifying process while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specifying processing unit 290 of the data processing apparatus 12 or the control unit 46A of the smart device 14, but may also be executed by the specifying processing unit 290 of the data processing apparatus 12 and the control unit 46A of the smart device 14. Also, the specifying processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specifying processing unit 290 of the data processing apparatus 12. For example, an acquisition unit acquires step count data using the camera 42 or the communication I/F 44 of the smart device 14, and the data is processed by the specifying processing unit 290 of the data processing apparatus 12. For example, an analysis unit is realized by the specifying processing unit 290 of the data processing apparatus 12, and analyzes data from the collection unit and the acquisition unit. For example, a generation unit is realized by the specifying processing unit 290 of the data processing apparatus 12, and generates a cooking menu using a generative AI. For example, a provision unit is realized by the output device 40 of the smart device 14 or the specifying processing unit 290 of the data processing apparatus 12, and provides the generated cooking menu to a user. The correspondence relationship between each unit and the device or the control unit is not limited to the above-described example, and various changes are possible.

An example form in which the specifying process is performed by the data processing apparatus 12 has been described, but the technology of the present disclosure is not limited to this, and the specifying process may be performed by the headset-type terminal 314.

### Fourth Embodiment

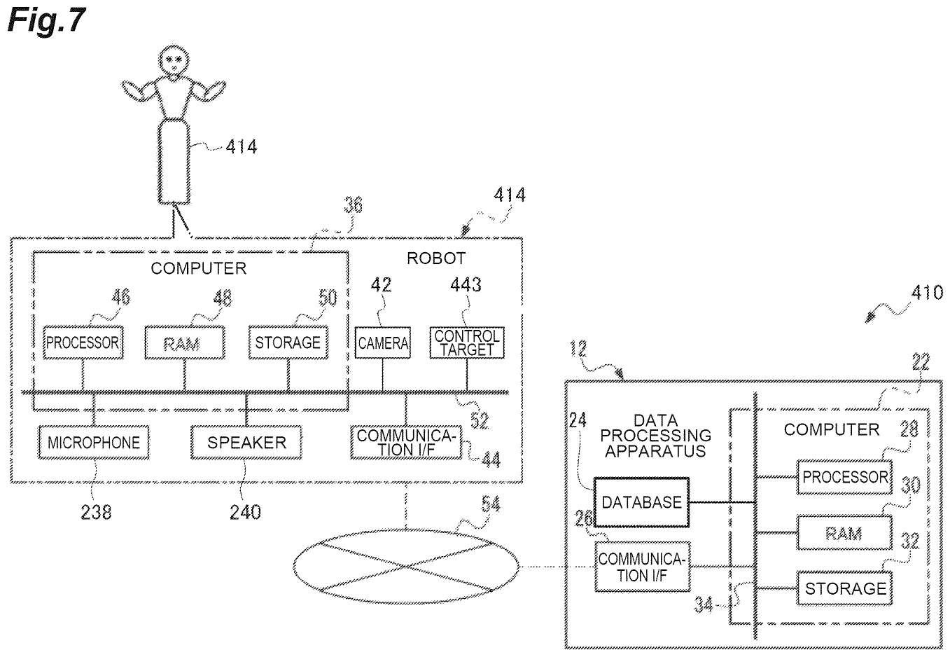

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

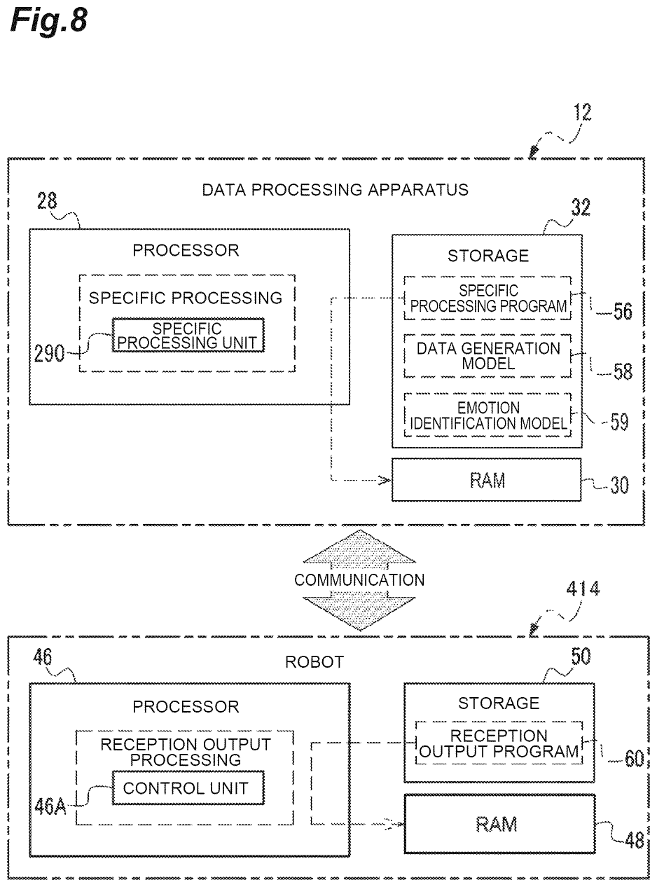

FIG. 8 illustrates an example of main functions of the data processing apparatus 12 and the robot 414. As illustrated in FIG. 8, in the data processing apparatus 12, a specifying process is performed by the processor 28. A specifying processing program 56 is stored in the storage 32.

The specifying processing program 56 is an example of a “program” according to the technology of the present disclosure. The processor 28 reads the specifying processing program 56 from the storage 32 and executes the read specifying processing program 56 on the RAM 30. The specifying process is realized by the processor 28 operating as a specifying processing unit 290 in accordance with the specifying processing program 56 executed on the RAM 30.

A data generation model 58 and an emotion identification model 59 are stored in the storage 32. The data generation model 58 and the emotion identification model 59 are used by the specifying processing unit 290.

In the robot 414, a reception output process is performed by the processor 46. A reception output program 60 is stored in the storage 50. The processor 46 reads the reception output program 60 from the storage 50 and executes the read reception output program 60 on the RAM 48. The reception output process is realized by the processor 46 operating as a control unit 46A in accordance with the reception output program 60 executed on the RAM 48.

Next, a specifying process by the specifying processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 4.1

Since the flow of the specifying process is the same as that in Example 1.1 described in the first embodiment, a description thereof is omitted.

### Example 4.2

Since the flow of the specifying process is the same as that in Example 1.2 described in the first embodiment, a description thereof is omitted.

The specifying processing unit 290 transmits a result of the specifying process to the robot 414. In the robot 414, the control unit 46A causes the speaker 240 and the control target 443 to output the result of the specifying process. The microphone 238 acquires voice indicating a user input for the result of the specifying process. The control unit 46A transmits voice data indicating the user input acquired by the microphone 238 to the data processing apparatus 12. In the data processing apparatus 12, the specifying processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specifying processing unit 290 performs the above-described specifying process while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specifying processing unit 290 of the data processing apparatus 12 or the control unit 46A of the smart device 14, but may also be executed by the specifying processing unit 290 of the data processing apparatus 12 and the control unit 46A of the smart device 14. Also, the specifying processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specifying processing unit 290 of the data processing apparatus 12. For example, an acquisition unit acquires step count data using the camera 42 or the communication I/F 44 of the smart device 14, and the data is processed by the specifying processing unit 290 of the data processing apparatus 12. For example, an analysis unit is realized by the specifying processing unit 290 of the data processing apparatus 12, and analyzes data from the collection unit and the acquisition unit. For example, a generation unit is realized by the specifying processing unit 290 of the data processing apparatus 12, and generates a cooking menu using a generative AI. For example, a provision unit is realized by the output device 40 of the smart device 14 or the specifying processing unit 290 of the data processing apparatus 12, and provides the generated cooking menu to a user. The correspondence relationship between each unit and the device or the control unit is not limited to the above-described example, and various changes are possible.

An example form in which the specifying process is performed by the data processing apparatus 12 has been described, but the technology of the present disclosure is not limited to this, and the specifying process may be performed by the robot 414.

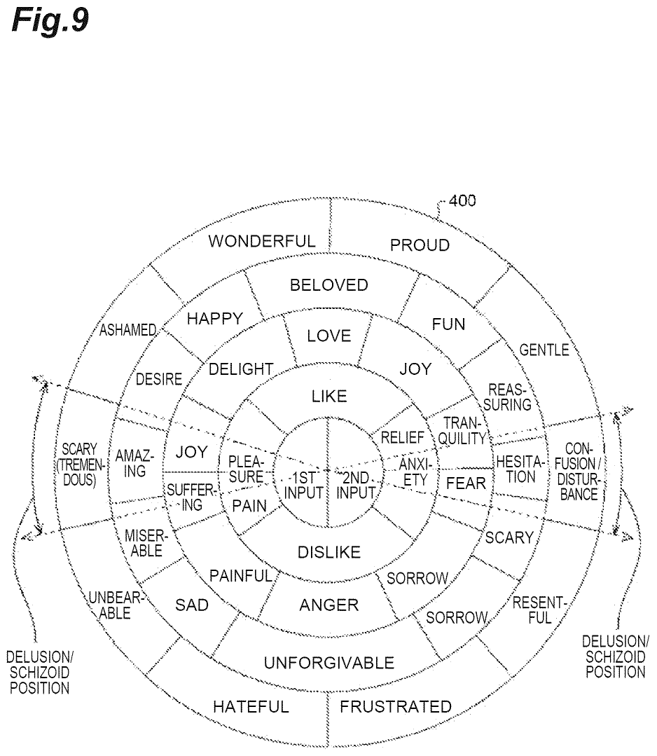

Note that the emotion identification model 59 as an emotion engine may determine a user's emotion according to a specific mapping. For example, the emotion identification model 59 may determine the user's emotion according to an emotion map (see FIG. 9), which is a specific mapping. Also, the emotion identification model 59 may similarly determine the robot's emotion, and the specifying processing unit 290 may perform a specifying process using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

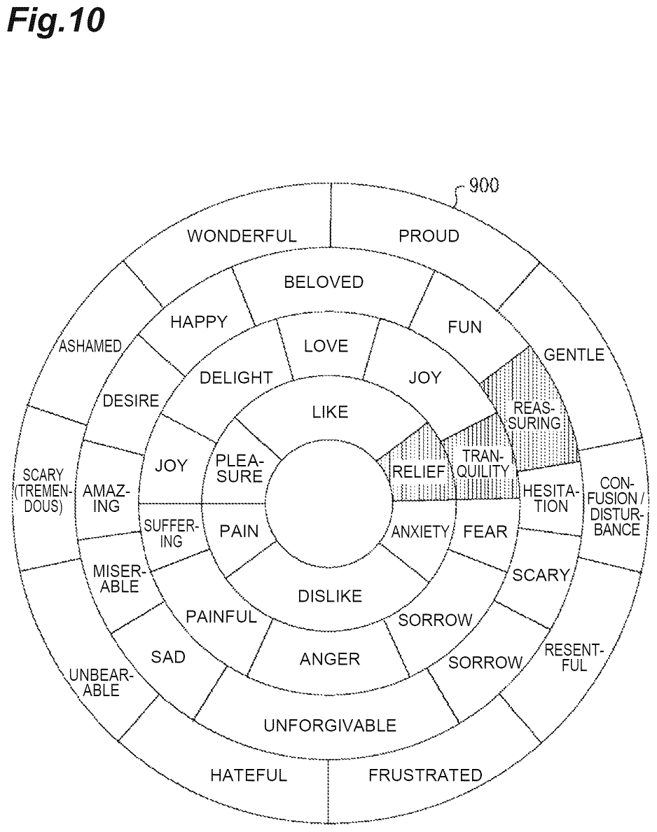

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a Saas (Software as a Service) format.

An example form in which the specifying process is performed by one computer 22 has been described, but the technology of the present disclosure is not limited to this, and distributed processing for the specifying process may be performed by a plurality of computers including the computer 22. For example, the data generation model 58 may be provided in an external device of the data processing apparatus 12, and the external device may generate data according to the input data.

An example form in which the specifying processing program 56 is stored in the storage 32 has been described, but the technology of the present disclosure is not limited to this. For example, the specifying processing program 56 may be stored in a portable computer-readable non-transitory storage medium such as a USB (Universal Serial Bus) memory. The specifying processing program 56 stored in the non-transitory storage medium is installed in the computer 22 of the data processing apparatus 12. The processor 28 executes the specifying process according to the specifying processing program 56.

Also, the specifying processing program 56 may be stored in a storage device such as a server connected to the data processing apparatus 12 via the network 54, and the specifying processing program 56 may be downloaded in response to a request from the data processing apparatus 12 and installed in the computer 22.

Note that it is not necessary to store all of the specifying processing program 56 in a storage device such as a server connected to the data processing apparatus 12 via the network 54, or to store all of the specifying processing program 56 in the storage 32, and a part of the specifying processing program 56 may be stored.

As hardware resources for executing the specifying process, various processors shown below can be used. Examples of the processor include a CPU, which is a general-purpose processor that functions as a hardware resource for executing the specifying process by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specifying process by using the memory.

The hardware resource that executes the specifying process may be configured by one of these various processors, or may be configured by a combination of two or more processors of the same type or different types (for example, a combination of a plurality of FPGAs, or a combination of a CPU and an FPGA). Also, the hardware resource that executes the specifying process may be one processor.

As an example of a configuration with one processor, first, there is a form in which one processor is configured by a combination of one or more CPUs and software, and this processor functions as a hardware resource for executing the specifying process. Second, there is a form in which a processor that realizes the functions of an entire system including a plurality of hardware resources for executing the specifying process with one IC chip, as represented by an SoC (System-on-a-chip) or the like, is used. In this way, the specifying process is realized using one or more of the various processors described above as hardware resources.

Furthermore, as a hardware structure of these various processors, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

It is to be understood that not all aspects, advantages and features described herein may necessarily be achieved by, or included in, any one particular example. Indeed, having described and illustrated various examples herein, it should be apparent that other examples may be modified in arrangement and detail.

A system including an input unit, a specifying unit, an anonymization unit, a transmission unit, a reception unit, a decryption unit, and a user interface unit, wherein the input unit is for receiving information regarding a user's health condition and care plan, the specifying unit has a function to specify personal information from the input information, the anonymization unit has a function to anonymize the specified personal information, the transmission unit has a function to transmit the anonymized information to a generative AI, the reception unit has a function to receive a response from the generative AI, the decryption unit has a function to decrypt the received response to the original personal information, and the user interface unit has a function to provide the decrypted information to a care staff.

In some examples, the specifying unit has a function to identify a user's name, address, health information, contact information, and the like using natural language processing technology and mark these as personal information, and the anonymization unit has a function to anonymize data by replacing the specified information with general labels or codes.

In some examples, the system enables a generative AI to generate an optimal care plan based on anonymized data by using a specific example such as “Please propose an optimal care plan based on User A's Health Condition X, age, and medical history” as a prompt sentence to be read into the generative AI.

An example system for processing anonymized data may include circuitry. The circuitry may be configured to: specify personal information from input data including the personal information; generate the anonymized data including anonymized personal information by anonymizing the specified personal information; transmit the anonymized data to a generative AI; receive a response from the generative AI; and decode the anonymized personal information included in the response received from the generative AI to the personal information.

In some examples, the anonymized data may be generated by replacing the specified personal information with other types of information.

In some examples, the anonymized personal information may be decoded to the personal information by referring to the other types of information used during anonymization of the personal information.

An example method of processing anonymized data may include: specifying personal information from input data including the personal information; the generating anonymized data including anonymized personal information by anonymizing the specified personal information; transmitting the anonymized data to a generative AI; receiving a response from the generative AI; and decoding the anonymized personal information included in the response received from the generative AI to the personal information.

What is claimed is:

1. A system for processing anonymized data, the system comprising circuitry,
wherein the circuitry is configured to:
specify personal information from input data including the personal information;
generate the anonymized data including anonymized personal information by anonymizing the specified personal information;
transmit the anonymized data to a generative AI;
receive a response from the generative AI; and
decode the anonymized personal information included in the response received from the generative AI to the personal information.

2. The system according to claim 1, wherein the anonymized data is generated by replacing the specified personal information with other types of information.

3. The system according to claim 2, wherein the anonymized personal information is decoded to the personal information by referring to the other types of information used during anonymization of the personal information.

4. A method of processing anonymized data, the method comprising:
specifying personal information from input data including the personal information;
generating the anonymized data including anonymized personal information by anonymizing the specified personal information;
transmitting the anonymized data to a generative AI;
receiving a response from the generative AI; and
decoding the anonymized personal information included in the response received from the generative AI to the personal information.
